(19) United States
(12) Patent Application Publication
(10) Pub. No.: US 2021/0279655 A1
(43) Pub. Date: Sep. 9, 2021

(54) OPTIMIZATION OF HUMAN-CENTRIC PROCESSES

(71) Applicant: Augmentir, Inc., New Castle, DE (US)

(72) Inventors: Lawrence Fan, Irvine, CA (US); Philip J. Huber, Orange, CA (US); John Canosa, Spencerport, NY (US); Russ Fadel, Pebble Beach, CA (US)

(21) Appl. No.: 17/251,723

(22) PCT Filed: Jun. 13, 2019
(86) PCT No.: PCT/US19/36894

§ 371 Date: Dec. 11, 2020

Related U.S. Application Data
(60) Provisional application No. 62/684,466, filed on Jun. 13, 2018.

(51) Int. Cl. G06Q 10/06

(52) U.S. Cl. CPC G06Q 10/0633; G06Q 10/06316; G06Q 10/063114

(57) ABSTRACT

A non-transitory computer-readable storage medium storing one or more programs, the one or more programs comprising instructions, which when executed by an electronic system with a display, cause the electronic system to display a human-centric process (HCP) authoring application window configured to allow an author to create one or more tasks for the human¬centric process, wherein HCP authoring application window displays one or more task cards, wherein at least one of the task cards includes HCP task characteristics data input fields, receive HCP task characteristics entered into the HCP task characteristics data input field of the task card by the author, determine whether the HCP task characteristics meets task authoring criteria, wherein the task authoring criteria is based on task status data and/or prior author process modification data.

### CROSS REFERENCE TO RELATED APPLICATIONS

The present application claims priority to U.S. Provisional Patent Application No. 62/684,466, filed Jun. 13, 2018, which is hereby incorporated by reference in its entirety.

### FIELD OF THE INVENTION

The present invention generally relates to creation and optimization of human-centric processes.

### BRIEF DESCRIPTION OF THE SEVERAL VIEWS OF THE DRAWINGS

The following detailed description of embodiments of the invention will be better understood when read in conjunction with the appended drawings of an exemplary embodiment. It should be understood, however, that the invention is not limited to the precise arrangements and instrumentalities shown.

In the drawings:

FIG. 1 is a diagram illustrating exemplary hardware and software components that may be used in connection with an exemplary embodiment of the present invention;

FIGS. 2A and 2B are flow charts illustrating exemplary methods of the present invention; and

FIGS. 3-8 are screen shots of exemplary user interfaces that may be used in connection with carrying out exemplary methods of the present invention.

### DETAILED DESCRIPTION OF THE EXEMPLARY EMBODIMENTS

Aspects of the present invention are useful in the field of human-centric operations in which new work procedures are authored to assist workers in performing a hands-on job such as equipment service, manufacturing assembly, or machine calibration, by way of example. The work procedure may include any combination of text, pictures, movies, three dimensional computer aided design (3D CAD), remote expert sessions, and mixed reality sessions, by way of example, to aid the worker in completing a task and tracking task completion. Such work procedures may be executed on any combination of computing devices including, smart phones, tablets, smart glasses, wearable computers, and personal computers, by way of example. Such computing devices may be connected to any number of input devices, such as sensors, smart tools, or smart equipment, by way of example.

In accordance with one aspect of an embodiment of the present invention, artificial intelligence (AI) is used to recommend the optimum the work procedure based on data collected from the execution and modification of prior procedures, or even the current procedure in some embodiments, taking into account high resolution data collected from the worker, the input device(s), and the computing platform(s). As used herein, “high resolution data” may refer to data that provides quality, dependable and/or objective information about the tasks being performed by the workers. More particularly, in this aspect of the present invention, an author of the work procedure is provided with information to assist the author to design the optimal work procedure for performing a particular task (e.g., instructions for hanging a painting or replacing a gasket seal on a generator that requires a specific torque reading for each fastener). This is accomplished using an AI engine which relies on historical data collected from other similar procedures that include similar steps or use similar tools and/or platforms, or the same procedure, to recommend an optimum work procedure design. For example, based on data generated through other workers performing the same/a similar task, the AI engine may determine that a series of time-lapse videos with lengths less than 18% of the expected step duration is ideal, instead of using alternative methods of instruction such as standard video, mixed-reality, or pictures. This results in the lowest total procedure execution time while still meeting a 100% quality target.

Existing software used for authoring (augmented) work procedures does not provide recommendations to the author to optimize the work procedures. Also, such software is not configured to accept as an input high resolution data from the worker, tools and sensors, or the computing platforms used by the worker, to allow such software to make optimization recommendations.

The following provides some examples of the recommendations that may be made by the system to an author of a work procedure, in accordance with exemplary embodiments of the invention. In one embodiment, a recommendation is made to reduce the length of a video used to illustrate a step in the process to make it more likely that the worker can complete the step in less than the target time. In another embodiment, a recommendation is made to replace first media with second media to reduce the time variability in the step, resulting in a lower average step completion time. In another embodiment, a recommendation is made to add visual media because 70% of the times a step is executed, a remote expert call was required, indicating that the instruction may not clear. In one embodiment, a recommendation is made to finalize one set of procedure steps over others based on the results returned by a built-in AB testing capability, which can automatically determine which of two or more steps is optimal for a procedure based on time, quality, or other desired metric. In another embodiment, a recommendation is made to group a series of steps together because each step requires the operator to use the same tool. In still a further embodiment, a recommendation is made to require the worker to watch a short video clip until the worker has executed the procedure at least 5 times.

In accordance with another aspect of an embodiment of the present invention, an AI-based recommendation engine is used for optimizing procedures that are carried out by human workers. This embodiment may be used to help the work procedure author optimize the procedures for the desired outcome metric by analyzing the data collected through instrumenting the human-centric procedures. By way of example, outcomes may be optimized for quality, cycle time, cost, and traceability among other metrics. Using the data collected during the execution of all instances of all procedures (including previous procedures), the AI-based models direct the procedure author towards the optimum series of steps and step instructions/content that lead to the most favorable outcome. In addition, other AI and machine learning techniques can be used to identify root causes of problems that may have occurred during the execution of a procedure. For example, in a manufacturing operation, the data collected by the system might identify which particular step in a procedure seemed anomalous in a production run with a high rate of scrapped work.

This embodiment of the present is superior to existing methods. More particularly, existing methods for human-centric work treat the worker essentially as a “black box”. The worker is given a set of tasks to do, often with paper-based instructions, and very little data is collected during the execution of task until the end result is known. For automated manufacturing systems, on the other hand, computers and sensors track events down to the millisecond level to help optimize such automated systems. The present invention provides a way of instrumenting the worker, like existing automated systems, as well as the sensors and systems used by the worker in the execution of each procedure, without creating an undue burden on the work procedure author or the worker executing the procedure.

The following provides some examples illustrating this aspect of the invention. In one embodiment, a short burst of quality or scrap problems can be analyzed to understand what step in the procedure appears anomalous to previous iterations of the procedures that resulted in satisfactory quality outcomes. The quality assurance team and instruction author can be directed precisely to the area that caused the problem with recommendations on how to fix the problem. In another embodiment, the data collected during the execution of a series of problem troubleshooting procedures may be collected and fed into a machine learning system which generates and continuously improves an automated response system (e.g., a bot), freeing up the human experts to answer more difficult or unusual problems. In a further embodiment, a recommendation based on AB testing of different variations of a procedure is made that identifies the procedure variation that provides the best results when considering time, cost, and quality as factors. In still a further embodiment, a recommendation is made to group a series of steps based on a common tool being used by the worker in each step to increase the efficiency of the operation. In another exemplary embodiment, a recommendation is made to group a series of steps based on a common target area being worked on in order to increase the efficiency of the operation. In another exemplary embodiment, a recommendation is made to combine one or more steps. In another exemplary embodiment, a recommendation is made to add one or more steps. In another exemplary embodiment, a recommendation is made to delete one or more steps.

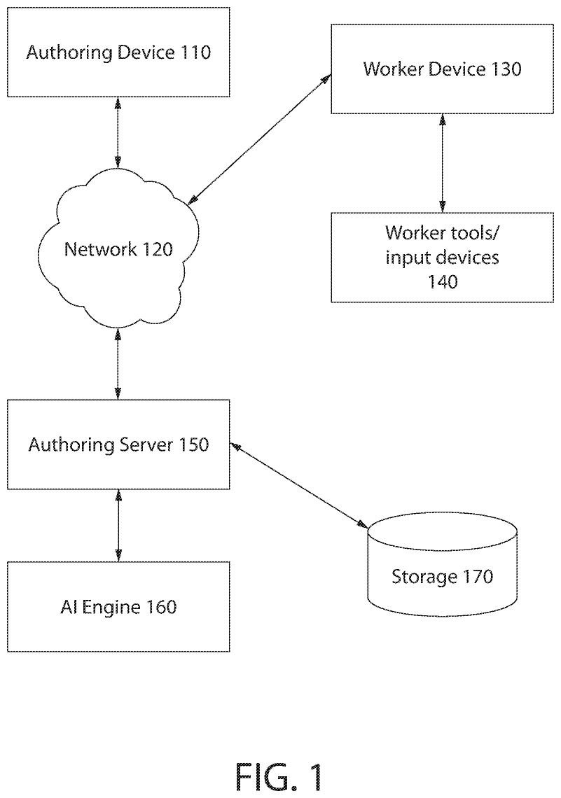

The exemplary methods of embodiments of the present invention may be carried out by a system 100 that employs a client/server architecture such as, for example, the collection of components illustrated and described with reference to FIG. 1.

With reference to FIG. 1, authoring device 110 may be any device (e.g., personal computer, tablet or other computing device) capable of executing software configured to author work procedures. Such software may be stored locally on authoring device 110, or may be stored on application server 150 and accessed by authoring device 110 over a computer network 120, such as the Internet, intranet, or other wide or local area network. Application server 150 may comprise or access AI engine 160, which is configured to perform the optimization and recommendation procedures described herein. Workers may employ one or more worker device 130 and/or worker tools/input devices 140 (examples of which were described previously) to execute the work procedures, in connection with worker input tools and devices 140 (examples of which were also described previously). The data generated by execution of such work procedures may be uploaded to application server 150 through network 120, and stored in one or more databases 170. Such data may be used by AI engine 160 to make recommendations and/or optimize work procedures, as described more fully herein.

Thus, for example, an author using authoring device 110 to create a work procedure for a task may be guided by software that relies on input from AI engine 160 to make recommendations about the particular steps to be taken, the order in which the steps should be performed, the tools to be used in performing the steps, and/or details about the manner in which the instruction is to be presented to the worker (e.g., the media to be used, the length of the instruction). Further, for example, data associated with a worker using worker device 130 (e.g., a computing device such as a smartphone) and tools/input devices 140 to execute a work procedure is collected. AI Engine 160 can assess this data (e.g., using one or more machine learning algorithms) to identify, with precision, any problems associated with the work procedure and execution of the same and suggest alterations to the work procedure accordingly.

While FIG. 1 illustrates the application server 150 and the AI engine 160 as separate from the authoring device, in some embodiments, the functionality of the application server 150 and the AI engine 160 may be incorporated in the authoring device 110.

To the extent data and information is communicated over network 120 (e.g., the Internet or an Intranet), one or more network servers may be employed. The network server may also comprise one or more processors, computer readable storage media that store programs (computer readable instructions) for execution by the processor(s), and an interface between the processor(s) and computer readable storage media. When data is requested through an application, such as an Internet browser, the network server may receive and process the request. The network server may send the data or application requested along with user interface instructions for displaying a user interface on device (e.g., authoring device 110, worker device 130).

The computers/devices referenced herein are specially programmed to perform the functionality described herein.

The non-transitory computer readable storage media (e.g., implemented on any of the computers or devices provided herein) that store the programs (e.g., software modules comprising computer readable instructions) may include volatile and non-volatile, removable and non-removable media implemented in any method or technology for storage of information such as computer-readable instructions, data structures, program modules, or other data. Computer readable storage media may include, but is not limited to, RAM, ROM, Erasable Programmable ROM (EPROM), Electrically Erasable Programmable ROM (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computer system and processed.

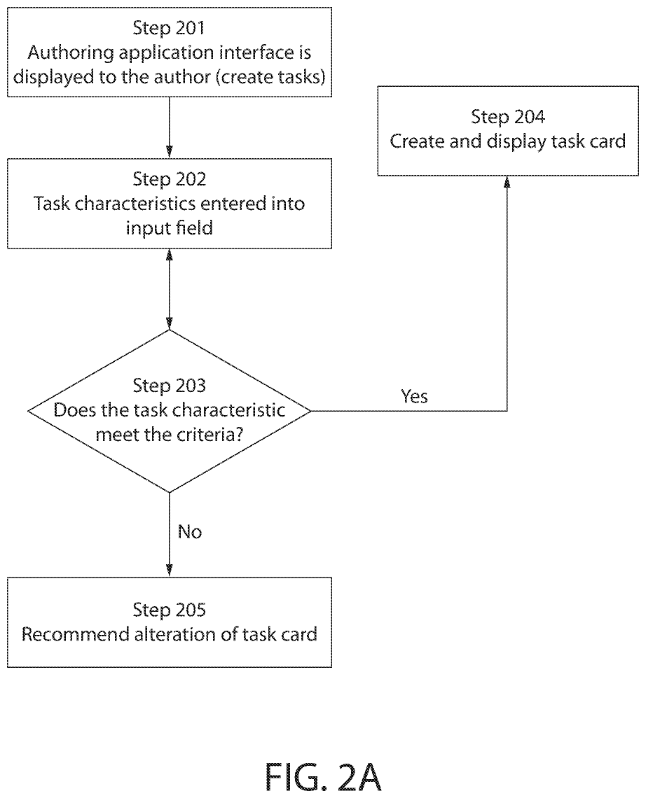

FIGS. 2A and 2B illustrates methods by which the high-resolution data is collected and used in connection with creating, making recommendations as to and optimization of work procedures, as described more fully herein.

With reference to FIG. 2A, an exemplary method of an embodiment of the present invention is now illustrated. In step 201, a human-centric process (HCP) authoring application interface is displayed to the author. The interface is configured to allow the author to create one or more tasks for the human-centric process. More particularly, the HCP authoring application interface displays one or more task cards, at least one of which includes HCP task characteristics data input fields. As used herein, the term task card may refer to a (e.g., visual) representation of HCP task characteristics for a task in a human centric process. In step 202, HCP task characteristics, entered into the HCP task characteristics data input field of the task card by the author, are received. In step 203, it is determined whether the HCP task characteristics meets task authoring criteria. Task authoring criteria may be based on task status data and/or prior author process modification data. Examples of task status data may include prior worker data representative of tasks performed by prior workers; remote expert data representative of an expert's need to consult with a worker on a particular task; and quality metrics from third parties including customer relationship management (CRM) systems, machine testing systems, and task tracking/ticketing software. In response to a determination that the HCP task characteristics meets task authoring criteria, the task card for the HCP is created and displayed, in step 204. In response to a determination that the HCP task characteristics does not meet task authoring criteria, a recommendation to alter one or more characteristics of the task card is provided in a recommendation area of the HCP authoring application window and the task card for the HCP is displayed in a task card area of the HCP authoring application window, in step 205.

In one embodiment, the HCP task characteristics includes at least one of: a task description characteristic that specifies a description of a task, a worker verification characteristic that specifies how a worker will verify that a step has been completed, a demonstration characteristic that specifies a demonstration about how a step should be completed, and a task expected duration characteristic that specifies an amount of time the worker needs to complete a task.

In some embodiments, the task authoring criteria includes a criterion that is met when an estimated amount of time the worker needs to complete a task exceeds the specified amount of time the worker needs to complete the task. In this embodiment, in step 203, a determination is made (e.g., it is determined whether the estimated amount of time the worker needs to complete a task exceeds the specified amount of time the worker needs to complete the task). If so, in step 205, a recommendation is provided to an author (e.g., to replace the task step with a second task step having a shorter expected execution time and including an alternative task characteristic (e.g., if a demonstration video was provided in the original task, the second task may include a sequence of 3 images).

In some embodiments, the demonstration characteristic includes a first media and the task authoring criteria includes a criterion that is met when an estimated duration of the first media and/or an estimated amount of time the worker needs to complete a task exceeds the specified amount of time the worker needs to complete a task in the task expected duration characteristic. In this embodiment, in step 203 a determination is made (e.g., it is determined whether the estimated duration of the first media and/or an estimated amount of time the worker needs to complete a task exceeds the specified amount of time the worker needs to complete a task in the task expected duration characteristic). If so, in step 205, a recommendation provided to an author (e.g., to replace the task step with a second task step having a second media). In some of these embodiments, the first media and the second media may each be at least one of: mixed reality media, three dimensional computer aided design assembly/disassembly video, standard video, static image, and audio.

In some embodiments, the task authoring criteria includes a criterion that is met when historical data regarding a specified task description indicates that that a worker may need additional assistance to complete the task and the HCP task characteristics do not include a demonstration characteristic. Examples of historical data may include prior worker task status data and/or prior author process modification data. The prior worker task status data may indicate an undesirable outcome such as the worker took too long to complete the task or had to call an expert for assistance. The prior author process modification data may indicate that the prior author for a prior process modified the process step as a result of the prior worker task status data indicating an undesirable outcome. In this embodiment, in step 203, a determination is made (e.g., it is determined whether the historical data regarding a specified task description indicates that a worker may need additional assistance to complete a task and the HCP task characteristics do not include a demonstration characteristic). If so, in step 205, a recommendation is made to an author (e.g., to add a new demonstration).

In some embodiments, the task authoring criteria includes a criterion that is met when the task cards include a first task card and a second task card that are not sequentially ordered, and when the first task card and the second task card both include an indication that a common tool (e.g., a Bluetooth torque wrench) is needed to complete the tasks specified in the first task card and the second task card. In this embodiment, in step 203, a determination is made (e.g., it is determined whether the first task card and the second task card both include an indication that a common tool is needed to complete the tasks specified in the first task card and the second task card). If so, in step 205, a recommendation is provided to the author (e.g., to sequentially order the first task card and second task card together).

In some embodiments, the task authoring criteria includes a criterion that is met when historical data regarding a specified task description indicates that that a novice worker may need additional assistance to complete the task. In this embodiment, in step 203, a determination is made (e.g., it is determined whether the historical data regarding a specified task description indicates that that a novice worker may need additional assistance to complete the task). If so, in step 205, a recommendation is provided to the author (e.g., to add a new demonstration displayed to the novice worker until the novice work has performed the task greater than a predetermined number of times).

In some embodiments, the task authoring criteria includes a criterion that is met when the task cards include a first task card and a second task card that are not sequentially ordered, and when the first task card and the second task card both include an indication that a common area of a work site is needed to complete the tasks specified in the first task card and the second task card. In this embodiment, in step 203, a determination is made (e.g., it is determined whether the first task card and the second task card both include an indication that a common area of a work site is needed to complete the tasks specified in the first task card and the second task card). If so, in step 205, a recommendation is provided to the author (e.g., to sequentially order the first task card and second task card together).

With reference to FIG. 2B, another exemplary method of the present invention is described.

In step 221, a human-centric process (HCP) authoring application interface, configured to allow an author to edit one or more tasks associated with implementing the human-centric process, is displayed. The HCP authoring application interface displays one or more task cards. At least one of the task cards includes HCP task characteristic data input fields configured to receive HCP task characteristics of the task card by the author.

While each of a plurality of workers is performing the one or more tasks associated with the implemented human-centric process, worker task status data representative of the respective worker completing one of the tasks associated with the implemented human-centric process is received, in step 222. The current worker task status data comprises objective data, such as data from a tool (e.g., torque wrench) used by the worker, an image taken by the worker using camera-enabled device (e.g., smartphone), information processed from an image taken by the worker using image recognition technology, worker location data, and/or data entered by the worker (e.g., notes, text and/or voice recordings). Prior worker task status data and prior author process modification data for prior human-centric processes may also be received. The prior worker task status data may indicate an undesirable outcome such as the worker took too long to complete the task or had to consult with an expert for assistance. The prior author process modification data may indicate that the prior author for a prior process modified the process step as a result of the prior worker task status data indicating an undesirable outcome.

In step 223, it is determined whether the current worker task status data meets task completion criteria. In response to a determination that the worker task status data does not meet task completion criteria, in step 224, a recommendation is provided to alter one or more characteristics of the task card in a recommendation area of the HCP authoring application window. In response to a determination that the current worker task completion data meets task completion criteria, in step 225, the task card for the HCP is displayed in the task card area of the HCP authoring application window.

In some embodiments, the current worker task completion data comprises at least one of: an image, a task completion time, and tool usage data generated by a tool used by the respective worker.

In some embodiments, the current worker task completion data includes task troubleshooting data.

In some embodiments, the task completion criteria includes a criterion that is met when, for a given task having two versions, factors representative of a first portion of the worker task completion data representative of a first version of the given task and the second portion of the worker task completion data representative of the second version of the given task indicate that the first portion of the work task completion data has a more favorable outcome as compared to a second portion of the worker task completion data. In such embodiments, if it is determined in step 223 that that the first portion of the worker task completion data has a more favorable outcome for the HCP, in step 224, a recommendation is provided to an author to use the first portion of the worker task completion data for the HCP. In response to a determination that the first portion of the worker task completion data has a less favorable outcome for the HCP, in step 224, a recommendation is provided to an author to use the second portion of the worker task completion data for the HCP.

In some embodiments, the task completion criteria includes a criterion that is met when, for a given task, task factors representative of the worker task completion data indicate that the task has an undesirable outcome. In such embodiments, in response to a determination that the factors representative of the worker task completion data indicate that the task has an undesirable outcome in step 223, a recommendation is provided to an author to alter the HCP task characteristics for the HCP, in step 224. In response to a determination that the factors representative of the worker task completion data indicate that the task has a desirable outcome in 223, the task is maintained for the HCP in step 225.

In some embodiments, the task factors representative of the worker task completion data include at least one of: a task complete time, a task completion cost, and a task completion quality value.

In some embodiments, the task authoring criteria includes a criterion that is met when the task cards include a first task card and a second task card that are not sequentially ordered, and the first task card and the second task card both include an indication that a common tool is needed to complete the tasks specified in the first task card and the second task card. In such embodiments, in response to a determination that the first task card and the second task card both include an indication that a common tool is needed to complete the tasks specified in the first task card and the second task card, a recommendation is made to the author, in step 224, to sequentially order the first task card and second task card together.

In some embodiments, the task authoring criteria includes a criterion that is met when the task cards include a first task card and a second task card that are not sequentially ordered, and when the first task card and the second task card both include an indication that a common area of a work site is needed to complete the tasks specified in the first task card and the second task card. In such embodiments, in response to a determination that the first task card and the second task card both include an indication that a common area of a work site is needed to complete the tasks specified in the first task card and the second task card, in step 224, a recommendation is provided to the author to sequentially order the first task card and second task card together.

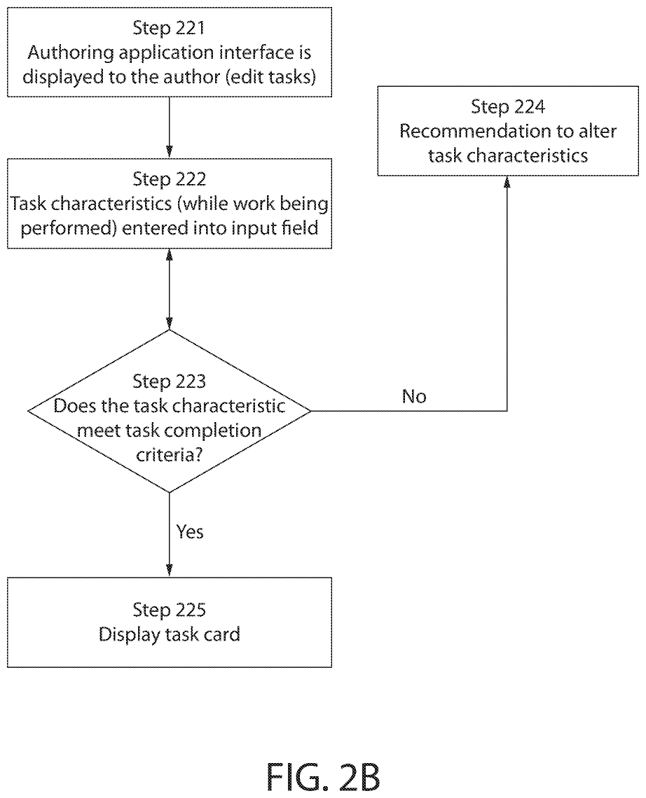

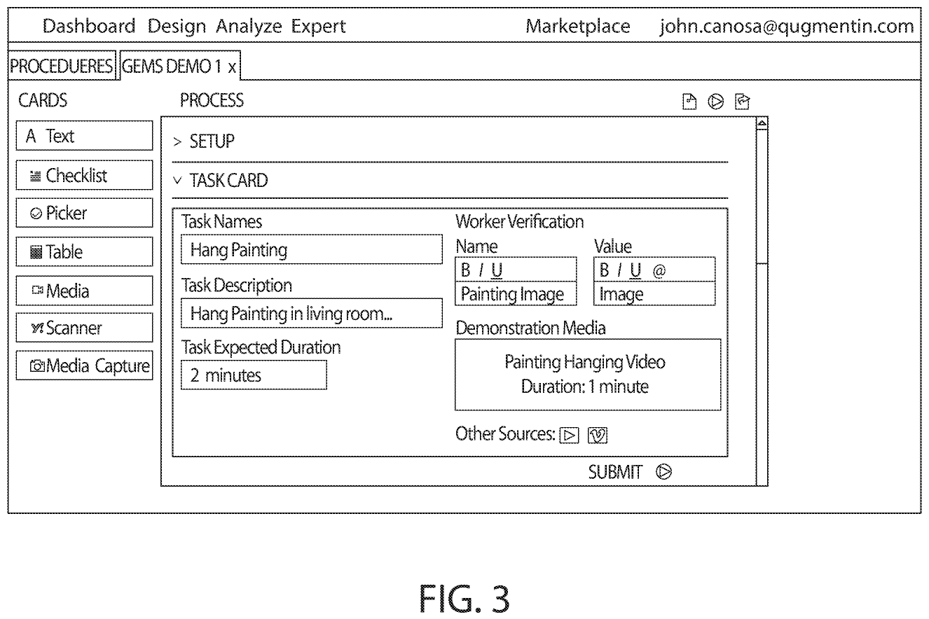

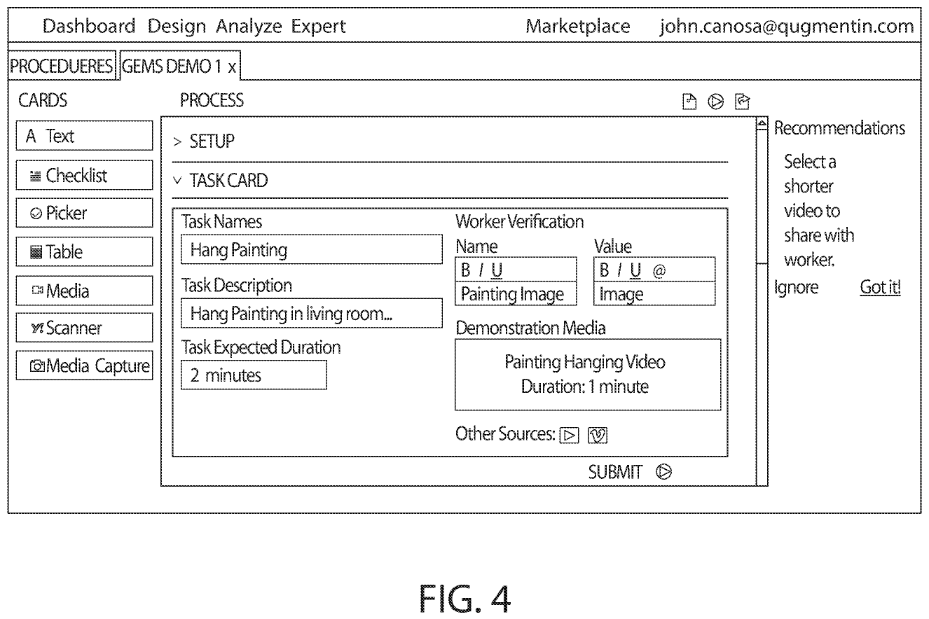

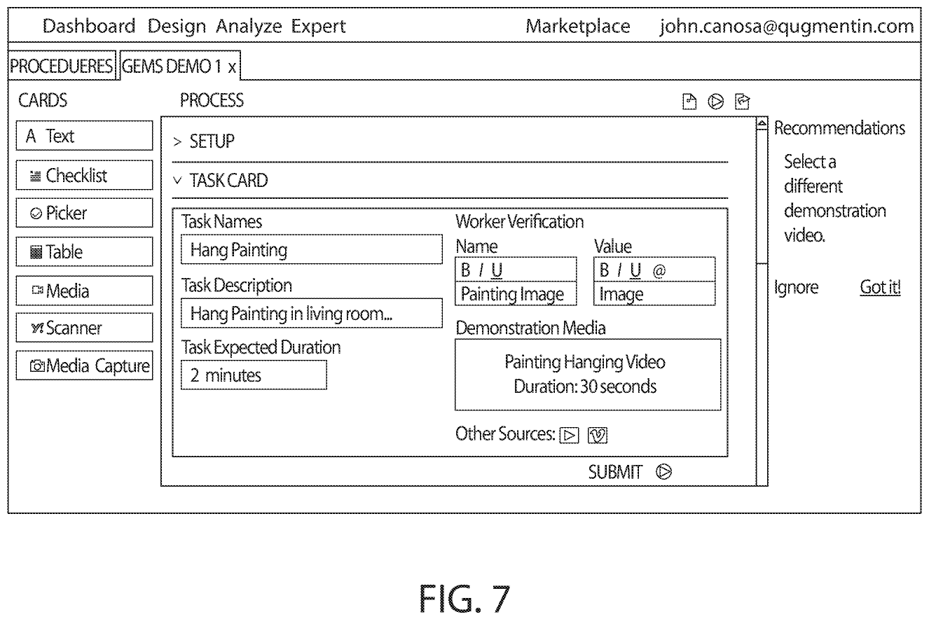

FIGS. 3-8 are exemplary screen shots that may be used in connection with an embodiment of the present invention. FIG. 3 is a screen shot that may be used by an author to create a work procedure. A task card may be used for this purpose with certain task characteristics. In this example, the task is to hang a painting. A description and expected duration are indicated. A worker verification via an image of the hung painting may also be indicated. The author selects a media for demonstrating how to hang the painting. In this example, the author chooses a video with a duration of 1 minute. Upon submission, the AI engine (e.g., AI engine 160 in FIG. 1) analyzes the data available to it that may be associated with this task, and compares it to the task card data created by the author. For example, the AI engine may evaluate prior worker task status data, such as data representative of workers that previously performed a similar task and took longer than 2 minutes to complete the task, and prior author process modification data, such as data representative of an author changing to a shorter demonstration video as a result of the prior workers taking too long to complete the task. As illustrated in FIG. 4, as a result of the evaluation, the AI Engine recommends that the author select a shorter video to demonstrate how to hang the painting. With reference to FIG. 5, the author has selected a 30 second video for the process.

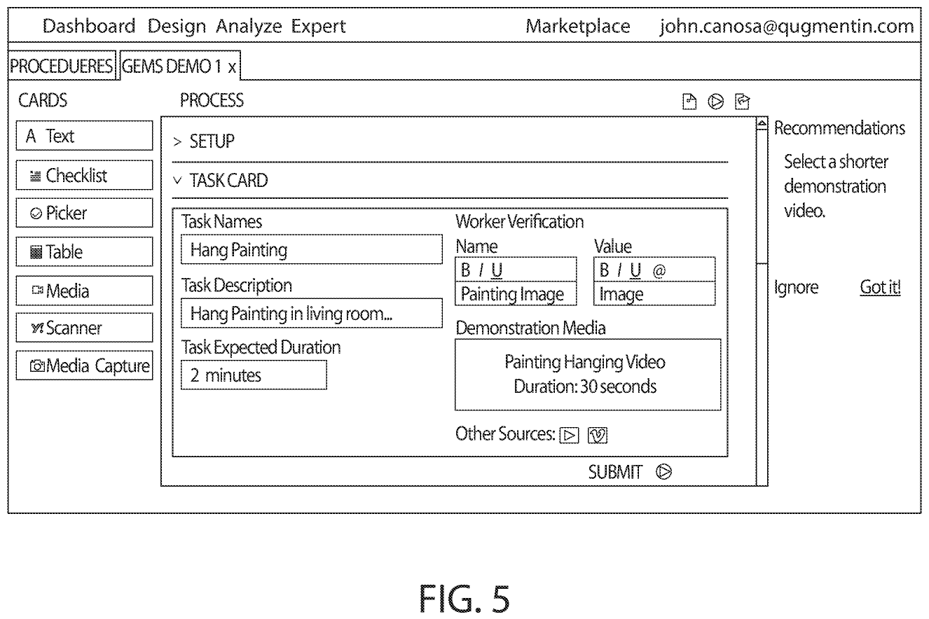

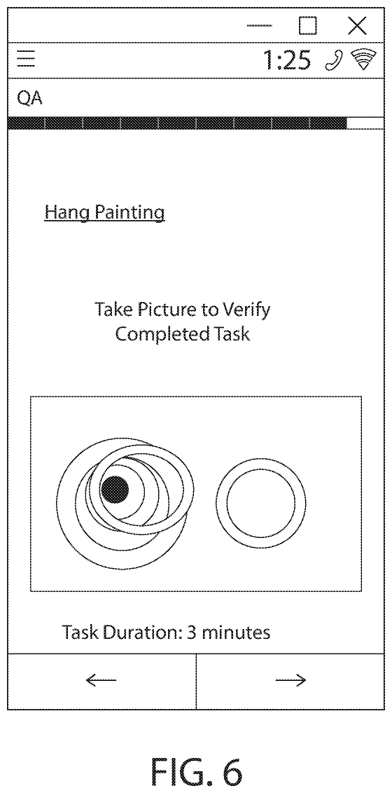

FIG. 6 illustrates a tool that the worker may use to capture data representative of the steps he has taken in connection with completing the task and/or completion of the task. In this example, the worker has taken a picture of the painting as hung. The tool indicates that the task has taken 3 minutes. In accordance with the invention, the application recognizes that the actual task duration (e.g., 3 minutes) is longer than the expected task duration (e.g., 2 minutes). Thus, as shown in FIG. 7, a recommendation is made to select a different demonstration video, which may allow the worker to successfully complete the task within the expected task duration.

It will be appreciated by those skilled in the art that changes could be made to the exemplary embodiments shown and described above without departing from the broad inventive concept thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and features of the disclosed embodiments may be combined. Unless specifically set forth herein, the terms “a”, “an” and “the” are not limited to one element but instead should be read as meaning “at least one”.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the method does not rely on the particular order of steps set forth herein, the particular order of the steps should not be construed as limitation on the claims. The claims directed to the method of the present invention should not be limited to the performance of their steps in the order written, and one skilled in the art can readily appreciate that the steps may be varied and still remain within the spirit and scope of the present invention.

1. A non-transitory computer readable storage medium storing one or more programs, the one or more programs comprising instructions, which when executed by an electronic system, cause the electronic system to:
provide a human-centric process (HCP) authoring application window configured to allow an author to create one or more tasks for the human-centric process, wherein HCP authoring application window comprises one or more task cards, wherein at least one of the task cards includes HCP task characteristics data input fields;
receive HCP task characteristics entered into the HCP task characteristics data input fields of the task card by the author;
determine whether the HCP task characteristics meets task authoring criteria, wherein the task authoring criteria is based on task status data and/or prior author process modification data;
in response to a first determination that the HCP task characteristics meets the task authoring criteria, create the task card for the HCP and cause the task card for the HCP to be displayed; and
in response to a second determination that the HCP task characteristics does not meet the task authoring criteria, provide a recommendation to alter one or more characteristics of the task card in a recommendation area of the HCP authoring application window and cause the task card for the HCP to be displayed in a task card area of the HCP authoring application window.

2. The non-transitory computer readable storage medium of claim 1, wherein the HCP task characteristics includes at least one of:
a task description characteristic that specifies a description of a task,
a worker verification characteristic that specifies how a worker will verify that a step has been completed,
a demonstration characteristic that specifies a demonstration about how the step should be completed, or
a task expected duration characteristic that specifies an amount of time the worker needs to complete the task.

3. The non-transitory computer readable storage medium of claim 2,
wherein the task authoring criteria includes a criterion that is met when an estimated amount of time the worker needs to complete the task exceeds the specified amount of time the worker needs to complete the task, and
wherein the electronic system is further caused to:
in response to a determination that the estimated amount of time the worker needs to complete the task exceeds the specified amount of time the worker needs to complete the task, provide a recommendation to the author to replace the step with a second step having a shorter expected execution time including at least one alternative task characteristic.

4. The non-transitory computer readable storage medium of claim 2,
wherein the demonstration characteristic includes a first media,
wherein the task authoring criteria includes a criterion that is met when an estimated duration of the first media and/or an estimated amount of time the worker needs to complete the task exceeds the specified amount of time the worker needs to complete the task in the task expected duration characteristic, and
wherein the electronic system is further caused to:
in response to a determination that the estimated duration of the first media and/or the estimated amount of time the worker needs to complete the task exceeds the specified amount of time the worker needs to complete the task in the task expected duration characteristic, provide a recommendation to the author to replace the step with a second step having a second media.

5. The non-transitory computer readable storage medium of claim 4, wherein the first media and the second media each is at least one of: mixed reality media, three dimensional computer aided design assembly/disassembly video.

6. The non-transitory computer readable storage medium of claim 2,
wherein the task authoring criteria includes a criterion that is met when historical data regarding a specified task description indicates that that a worker may need additional assistance to complete the task and the HCP task characteristics do not include the demonstration characteristic, and
wherein the electronic system is further caused to:
in response to a determination that the historical data regarding a specified task description indicates that a worker may need additional assistance to complete the task and the HCP task characteristics do not include the demonstration characteristic, provide a recommendation to the author to add a new demonstration.

7. The non-transitory computer readable storage medium of claim 2,
wherein the task authoring criteria includes a criterion that is met when the task cards include a first task card and a second task card that are not sequentially ordered, and when the first task card and the second task card both include an indication that a common tool is needed to complete the tasks specified in the first task card and the second task card, and
wherein the electronic system is further caused to:
in response to a determination that the first task card and the second task card both include an indication that the common tool is needed to complete the tasks specified in the first task card and the second task card, provide a recommendation to the author to sequentially order the first task card and the second task card together.

8. The non-transitory computer readable storage medium of claim 2,
wherein the task authoring criteria includes a criterion that is met when historical data regarding a specified task description indicates that that a novice worker may need additional assistance to complete the task, and
wherein the electronic system is further caused to:
in response to a determination that the historical data regarding the specified task description indicates that that the novice worker may need additional assistance to complete the task, provide a recommendation to the author to add a new demonstration to be displayed to the novice worker until the novice worker has performed the task greater than a predetermined number of times.

9. The non-transitory computer readable storage medium of claim 2,
wherein the task authoring criteria includes a criterion that is met when the task cards include a first task card and a second task card that are not sequentially ordered, and when the first task card and the second task card both include an indication that a common area of a work site is needed to complete the tasks specified in the first task card and the second task card, and
wherein the electronic system is further caused to:
in response to a determination that the first task card and the second task card both include an indication that the common area of the work site is needed to complete the tasks specified in the first task card and the second task card, provide a recommendation to the author to sequentially order the first task card and the second task card together.

10. (canceled)

11. A non-transitory computer readable storage medium storing one or more programs, the one or more programs comprising instructions, which when executed by an electronic system, cause the electronic system to:
provide a human-centric process (HCP) authoring application window configured to allow an author to edit one or more tasks associated with implementing the human-centric process, wherein the HCP authoring application window comprises one or more task cards, wherein at least one of the task cards includes HCP task characteristic data input fields configured to receive HCP task characteristics of the task card by the author;
while each of a plurality of workers is performing the one or more tasks associated with the implemented human-centric process, receive current worker task status data representative of a respective worker completing one of the tasks associated with the implemented human-centric process, wherein the worker task status data comprises objective data;
receive prior worker task status data and prior author process modification data for prior human-centric processes;
determine whether the current worker task status data meets task completion criteria, wherein the task completion criteria are based on the current worker task status data, the prior worker task status data and the prior author modifying step data;
in response to a first determination that the current worker task status data does not meet task completion criteria, provide a recommendation to alter one or more characteristics of the one or more task cards in a recommendation area of the HCP authoring application window and cause the task card for the HCP to be displayed in a task card area of the HCP authoring application window; and
in response to a second determination that the current worker task status data meets the task completion criteria, cause the task card for the HCP to be displayed in the task card area of the HCP authoring application window.

12. The non-transitory computer readable storage medium of claim 11, wherein the current worker task status data and/or the prior worker task status data comprises at least one of: an image, a task completion time, or tool usage data generated by a tool used by the respective worker.

13. The non-transitory computer readable storage medium of claim 11, wherein the current worker task status data and/or the prior worker task status data includes task troubleshooting data.

14. The non-transitory computer readable storage medium of claim 11,
wherein the task completion criteria includes a criterion that is met when, for a given task having two versions, factors representative of a first portion of the current worker task status data representative of a first version of the given task and a second portion of the current worker task status data representative of the second version of the given task indicate that the first portion of work task completion data has a more favorable outcome as compared to a second portion of the worker task completion data,
wherein the electronic system is further caused to:
in response to a determination that the first portion of the worker task completion data has the more favorable outcome for the HCP, provide a recommendation to the author to use the first portion of the current worker task status data for the HCP; and
in response to a determination that the first portion of the worker task completion data has a less favorable outcome for the HCP, provide a recommendation to the author to use the second portion of the current worker task status data for the HCP.

15. The non-transitory computer readable storage medium of claim 11,
wherein the task completion criteria includes a criterion that is met when, for a given task, task factors representative of the current worker task status data, the prior worker task status data and/or the prior author process modification data for the prior human-centric processes indicate that the task has an undesirable outcome,
wherein the electronic system is further caused to:
in response to a determination that the task factors indicate that the task has the undesirable outcome, provide a recommendation to the author to alter the HCP task characteristics for the HCP; and
in response to a determination that the task factors indicate that the task does not have the undesirable outcome, maintain the task for the HCP.

16. The non-transitory computer readable storage medium of claim 15, wherein the task factors include at least one of: a task complete time, a task completion cost, and a task completion quality value.

17. The non-transitory computer readable storage medium of claim 11,
wherein the task authoring criteria includes a criterion that is met when the task cards include a first task card and a second task card that are not sequentially ordered, and when the first task card and the second task card both include an indication that a common tool is needed to complete the tasks specified in the first task card and the second task card, and
wherein the electronic system is further caused to:
in response to a determination that the first task card and the second task card both include an indication that the common tool is needed to complete the tasks specified in the first task card and the second task card, provide a recommendation to the author to sequentially order the first task card and the second task card together.

18. The non-transitory computer readable storage medium of claim 11,
wherein the task authoring criteria includes a criterion that is met when the task cards include a first task card and a second task card that are not sequentially ordered, and when the first task card and the second task card both include an indication that a common area of a work site is needed to complete the tasks specified in the first task card and the second task card, and
wherein the electronic system is further caused to:
in response to a determination that the first task card and the second task card both include an indication that the common area of the work site is needed to complete the tasks specified in the first task card and the second task card, provide a recommendation to the author to sequentially order the first task card and the second task card together.

19. (canceled)

20. A non-transitory computer readable storage medium storing one or more programs, the one or more programs comprising instructions, which when executed by an electronic system, cause the electronic system to:
display a sequence of one or more task cards for a human-centric process (HCP) to a worker, wherein the task cards include content regarding the HCP;
determine whether characteristics of the task and worker meet certain criteria;
in response to a determination that the characteristics of the task and worker meet certain criteria, analyze the task and criteria to determine optimizations regarding one or more desired results of the sequence of the one or more task cards for the HCP; and
adjust the sequence, quantity and/or content of the task cards for the HCP displayed to the worker based on said optimizations.

21. The non-transitory computer readable storage medium of claim 20, wherein each task card comprises HCP characteristics data input fields.

22. The non-transitory computer readable storage medium of claim 20, determining whether the characteristics of the task and the worker meet the certain criteria, comprises causing the electronic system to:
determine an estimated amount of time the worker needs to complete the task.
